(19) United States
(12) Patent Application Publication
(10) Pub. No.: US 2025/0214081 A1
(43) Pub. Date: Jul. 3, 2025

(54) CONTROLLED RESERVOIR FILLING

(71) Applicant: NUCLERA LTD, Cambridge (GB)

(72) Inventors: Michal Jan Horka, Cambridge (GB); Sumit Kalsi, Cambridge (GB)

(21) Appl. No.: 18/846,585

(22) PCT Filed: Mar. 14, 2023
(86) PCT No.: PCT/EP2023/056483

§ 371 Date: Sep. 12, 2024

(30) Foreign Application Priority Data
Mar. 14, 2022 (GB) 2203522.4

(51) Int. Cl. B01L 3/00

(52) U.S. Cl. CPC B01L 3/502792; B01L 3/502715; B01L 2200/026; B01L 2200/0605; B01L 2200/148; B01L 2200/16; B01L 2400/0427

(57) ABSTRACT

Provided herein are methods for the accurately controlled filling of a reservoir on a microfluidic device with a defined area of fluid.

### FIELD OF THE INVENTION

Provided herein are methods for enabling precise loading of an aqueous phase reservoir covering more than one electrode on a microfluidic device with a defined area of fluid. This invention is in the field of fluid electrokinetics: Electrowetting-on-dielectric (EWoD) and Dielectrophoresis (DEP); and the devices using these phenomena.

### BACKGROUND TO THE INVENTION

Microfluidic devices for manipulating droplets or particles based on electrical signals have been extensively described. Electrokinesis (movement due to electrical signals) occurs as result of (1) a non-uniform electric field that influences the hydrostatic equilibrium of a dielectric liquid (dielectrophoresis or DEP) or (2) a change in the contact angle of the liquid on solid surface (electrowetting-on-dielectric or EWoD). DEP can also be used to create forces on polarizable particles to induce their movement. The electrical signal can be transmitted to a discrete electrode, a transistor, an array of transistors, or a sheet of semi-conductor film whose electrical properties can be modulated by an optical signal.

The manipulation of droplets by the application of electrical potential can be achieved on electrodes covered with an insulator or a dielectric or a series of insulators or dielectrics. Droplet manipulation as a result of an applied electrical potential is known as electrowetting. In the case of droplets in channels this can be achieved by causing the droplets, for example in the presence of an immiscible carrier fluid, to travel through a microfluidic channel defined by the walls of a cartridge or microfluidic tubing. Embedded in the walls of the cartridge or tubing are the electrodes covered with a dielectric layer each of which are connected to an electrical circuit capable of being switched on and off rapidly at intervals to modify the wetting properties of the droplet on the dielectric layer. This gives rise to the ability to steer the droplet along a given path.

In contrast to channel based microfluidics, digital microfluidics (DMF) utilizes alternating electrical signal on an electrode array for moving fluid on the surface of the array. Liquids can thus be moved on an open-plan device by electrowetting. Digital microfluidics allows precise control over the droplet operations including droplet movement, fusion, and separation DMF uses EWoD phenomena when droplets are actuated between two parallel electrodes (forming a cell gap) covered with a hydrophobic insulator or a dielectric. The electric field at the electrode-electrolyte interface induces a change in the surface tension, which results in droplet motion because of a change in droplet contact angle. The electrowetting effect can be quantitatively treated using Young-Lippmann equation:

$$cos θ - cos {θ}_{0} = ( 1 / 2 {γ}_{LG} ) c \cdot {V}^{2}$$

where θ₀ is the contact angle when the electric field across the interfacial layer is zero, γ_{LG} is the liquid-gas tension, c is the specific capacitance (given as εᵣ. ε₀/t, where εᵣ is dielectric constant of the insulator/dielectric, ε₀ is permittivity of vacuum, t is thickness) and V is the applied voltage or electrical potential. The change in contact angle (inducing droplet movement) is thus a function of surface tension, electrical potential, dielectric thickness, and dielectric constant.

Planar DMF devices consist of two substrates separated by a cell gap, typically of several hundred microns. In this cell gap, an electric potential is applied to manipulate aqueous droplets by actuating electrodes to alter the surface wettability. For a real-world application, reagents/samples are to be loaded into this cell gap to form interstitial reservoirs and then smaller daughter droplets dispensed from the reservoir.

When a droplet is actuated by EWoD, there are two opposing sets of forces that act upon it: an electrowetting force induced by electric field and resistant forces that include the drag forces resulting from the interaction of the droplet with filler medium and the contact line friction. The minimum voltage applied to balance the electrowetting force with the sum of all drag forces (threshold voltage) is variably determined by the thickness-to-dielectric contact ratio of the insulator/dielectric, (t/εᵣ)^{1/2}. Thus, to reduce actuation voltage, it is required to reduce (t/εᵣ)^{1/2} (i.e., increase dielectric constant or decrease insulator/dielectric thickness). To achieve low voltage actuation, thin insulator/dielectric layers must be used. However, the deposition of high quality thin insulator/dielectric layers is a technical challenge, and these thin layers are easily damaged before the desired electrowetting contact angle is large enough to drive the droplet is achieved. Most academic studies thus report the use of much higher voltages >100V on easily fabricated, thick dielectric films (>3 μm) to effect electrowetting.

High voltage EWoD-based devices with thick dielectric films, however, have limited industrial applicability largely due to their limited droplet multiplexing capability. The use of low voltage devices including thin-film transistors (TFT) and optically-activated amorphous silicon layers (a-Si) have paved the way for the industrial adoption of EWoD-based devices due to their greater flexibility in addressing electrical signals in a highly multiplex fashion. The driving voltage for TFTs or optically-activated a-Si are low (typically <15 V). The bottleneck for fabrication and thus adoption of low voltage devices has been the technical challenge of depositing high quality, thin film insulators/dielectrics. Hence there has been a particular need for improving the fabrication and composition of thin film insulator/dielectric devices.

EWoD uses electric field for manipulation of liquid droplets and to perform droplet operations such as movement, mixing and splitting. The droplets are usually generated from an interstitial reservoir, formed in the cell gap (defined by the spacer introduced between two electrically addressable substrates), which is metered in via a fluid applicator e.g. pipette or automated fluid delivery sub-system.

Loading of a metered area in a bubble free manner is critical. DMF devices have a low surface energy coat inside the cell gap; this together with a relatively hydrophillic plastic housing on the port makes the loading difficult. These plastic housing tend to draw the liquid back out of the EWoD to fill the plastic port instead of the interstitial reservoir in the cell gap. During the process of loading, air bubbles can easily be introduced which block the reservoir filling and affects its function. Pressurising of the liquid in order to force entry often results in the liquid being forced back out of the inlet port when the pressure is released.

There are many prior art methods of loading EWoD devices which are sub-optimal. For example US2015352544 describes a system configured to conduct designated reactions for biological or chemical analysis. The system includes a liquid-exchange assembly comprising an assay reservoir for holding a first liquid, a receiving cavity for holding a second liquid that is immiscible with respect to the first liquid, and an exchange port fluidically connecting the assay reservoir and the receiving cavity. The system also includes a pressure activator that is operably coupled to the assay reservoir of the liquid-exchange assembly. The pressure activator is configured to repeatedly exchange the first and second liquids by (a) flowing a designated volume of the first liquid through the exchange port into the receiving cavity and (b) flowing a designated volume of the second liquid through the exchange port into the assay reservoir. The system also includes a fluidic system that is in flow communication with the liquid-exchange assembly.

US2020108396 describes a microfluidic device which comprises upper and lower spaced apart substrates defining a fluid chamber therebetween; an aperture for introducing fluid into the fluid chamber; and a fluid input structure disposed over the upper substrate and having a fluid well for receiving fluid from a fluid applicator inserted into the fluid well. The fluid well communicates with a fluid exit provided in a base of the fluid input structure, the fluid exit being adjacent the aperture. The fluid well comprises first, second and third portions, with the first portion of the well forming a reservoir for a filler fluid; and the second portion of the well being configured to engage with a good fit against an outer surface of a fluid applicator inserted into the fluid well. The third portion of the well communicates with the fluid exit and has a diameter at the interface between the third portion and the second portion that is greater than the diameter of the second portion at the interface between the third portion and the second portion.

It is therefore an object of the invention to provide an improved method for loading multiple evenly sized aqueous liquid areas into EWoD devices. Any operation on DMF based devices, requires precise measurement of droplets and calibrations to compensate for variability in fabrication techniques. For instance, in order to accurately dispense droplets from a reservoir held on the device, accurate control of the fill area of the reservoir is needed. Reservoir volume is a function of cell gap height and the actuated area of the DMF filled during loading. The volume is therefore defined by the area, which is in turn defined by the number of actuated pixels. Variations in gap height and interactions between aqueous reagents and the loading ports makes loading a consistent area hard to achieve. Loading errors can give erroneous reservoir filling for applications where reagents are loaded at regular intervals to run cycles. For AM-EWoD (active matrix electrowetting on dielectric) DMF, the high resolution active matrix on the backplane of the TFT adds complexity to reservoir loading as the user (or an algorithm) cannot easily determine the level to which the reservoir has to be filled to. Conventional passive EWoD devices have a discrete reservoir electrode, which makes it easier to fill them by providing visual and/or electronic feedback.

Planar DMF devices consist of two substrates separated by a cell gap, typically of several hundred microns. In this cell gap, an electric potential is applied to manipulate aqueous droplets by actuating electrodes to alter the surface wettability. For a real-world application, reagents/samples are to be loaded into this cell gap to form interstitial reservoirs and then smaller daughter droplets dispensed from the reservoir. The success rate for dispensing daughter droplets, the dispense accuracy, and the dispense precision are all dependent on the area of the reservoir matching expectation. It is difficult to control the reservoir filling by metering an exact volume into the cell gap, with difficulties including cell gap variation that causes under fill or overfill and the hydrophobicity of Teflon and/or plastic housing on the DMF device giving rise to capillary forces. Such problems are especially acute for loading multiple reservoirs simultaneously.

U.S. Pat. No. 7,763,471 describes loading a fluidic device from reagents on a part of the chip outside the device, i.e. the device contains wells that are separate to the DMF.

U.S. Pat. No. 8,821,705 shows a digital microfluidics system loaded with a single pipette.

US 2011/0220505 describes a method for transferring liquid on a EWoD device using actuation alone to initiate a flow of liquid from a reservoir. The actuation for entry can be performed using multiple channels (‘toothed electrodes’). The teeth are used to move and steer the liquid.

US2017/0266653 describes methods of concentration beads in droplets using microfluidics and droplet handling operations. The accuracy of reservoir formation and droplet dispensing is not mentioned.

US20040055891 describes methods and devices for electrowetting operations. The accuracy of reservoir formation and droplet dispensing is not mentioned.

US20190168223 describes digital microfluidic devices and methods of using them. The accuracy of reservoir formation and droplet dispensing is not mentioned.

U.S. Pat. No. 6,565,727 describes methods for manipulating droplets on micro-actuator devices. The accuracy of reservoir formation and droplet dispensing is not mentioned.

### SUMMARY OF THE INVENTION

Provided herein is a method for the controlled filling of a reservoir on a microfluidic device. More specifically, a method for controlled filling of a reservoir on an electrowetting on dielectric (EWoD) device.

Loading of reagent is a function of several inter-dependent processes; EWoD forces to draw (and retain) the reagent in; capillary forces to draw the reagent into the plastic port, fluctuations in the cell gap during a pressure driven load; surface tension of the reagents and the Laplace pressure defined by the shape of the reagent in the plastic port and the cell gap. Typically interior surfaces pf the device are more hydrophobic than the surfaces of the loading device. The invention relates to improved method for loading multiple aqueous reagents and with a higher accuracy for the target and metered volumes. Therefore, the presented method is especially beneficial for loading reagents with high surface tension and for using plastics to design the fluid delivery housing which are usually hydrophilic.

Provided herein is a planar electrowetting on dielectric (EWoD) device with droplets covering multiple pixels having at least 2 connected regions, the first region containing more than 90% of the area of the droplet and having an aspect ratio 3:1 or less and the second containing less than 10% of the total drop area and having an aspect ratio of more than 3:1, the second region functioning to visually indicate when the drop has reached an intended area.

The reservoir is typically square or rectangular in shape. However the reservoir may be other shaped such as triangular or hexagonal. The shape of the reservoir is controlled by the shape of the electrode pixels being actuated. Where the reservoirs are for example triangular, the elongated protrusions may also be triangular.

Provided herein is a method for visual indication of drop or reservoir area. The measurement of area requires a change in the shape of the droplet. For instance to measure a large drop of enclosed aqueous liquid on the panel, changing the shape of the enclosed liquid to include protrusions indicates the area of the liquid. For example a square covering say 10×10 pixels (100 pixel area) is difficult to measure an accurate area. A difference of 5% in a square may be difficult to measure. If the liquid covers a linear area of 100 pixels, when the area is 5 pixels too small the difference is easier to detect as the line only covers 95 pixels. Thus the area of long thin shapes is easier to accurately measure than square shapes. Disclosed is a way of accurately measuring the area of an enclosed aqueous fluidic liquid on an electrowetting on dielectric (EWoD) device by dynamically elongating the enclosed liquid to determine the size covered and allowing the enclosed liquid to return to a more compact shape once the area is known. The enclosed aqueous fluidic liquid can be a reservoir from which droplets are dispensed, or dispensed droplets.

The method can be applied to loading a reservoir. By introducing virtual calibration structures on the interstitial reservoirs of the device, a visual signal is produced which assists in the accurate loading of the reservoir with a defined area of liquid. These calibration structures are formed during the loading cycle of reagents and merged into the reservoirs during the dispense cycling. In effect the calibration structures are temporarily actuated electrodes on the far side of the reservoir electrodes from the fluid inlet. Once these temporally transient areas are filled, the electrodes forming the calibration structures are switched off and the liquid joins the main reservoir.

Disclosed herein is a method for dynamically controlling the shape of aqueous phase for the controlled filling of a reservoir on a planar electrowetting on dielectric (EWoD) device, the method comprising:
a. taking an EWoD device having an internal or external reagent source liquid;
b. actuating reservoir electrodes to form a defined reservoir of aqueous liquid on the device wherein the defined reservoir is separated from the source liquid by at least two electrodes; and
c. temporarily actuating electrodes on an opposing side of the reservoir to the source liquid to form one or more virtual calibration structures which are the last areas to fill, such that when the temporarily actuated electrodes are switched off the liquid becomes part of the reservoir, thereby accurately controlling the liquid area in the reservoir.

The virtual calibration structures can be elongated protrusions. There can be more than one elongated protrusions per reservoir. There can be three elongated protrusions per reservoir.

Each of the elongated protrusions may comprise 1 to 10% of the area of the reservoir.

An opposing side may be at 90 degrees or 180 degrees in relation to the source of the flowing liquid entering the reservoir. The virtual calibration structures may be on more than one opposing side from the reservoir entry.

US 2011/0220505 describes a method for transferring liquid on a EWoD device using actuation alone to initiate a flow of liquid from a reservoir. The actuation for entry can be performed using multiple channels (‘toothed electrodes’). The teeth are used to move and steer the liquid. Therefore the protrusions are on the same side as the incoming liquid. The invention as claimed herein using the protrusions on an opposing side to the inlet port in order to accurately control the loading area.

### BRIEF DESCRIPTION OF THE DRAWINGS

FIG. 1 shows a sequence of images (1-7) demonstrating precise formation of an aqueous reservoir with calibration structures driven with pressurized container embedded with an electromagnetic valve and a subsequent droplet dispense. The volume of the aqueous phase loaded is 7.2 μL, including both the reservoir to be formed and the calibration structures. The sizes of the actuated areas are 40×27 and 5×9 active elements on the device for main reservoir and calibration structures respectively. The time for filling the reservoir was approximately 120 seconds. The aqueous reagent loaded is 0.05% w/w Tween 20 in 150 mM NaCl and 20 mM HEPES, with dodecane as basefluid. Panel 7 of this figure shows dispense of 500 nL.

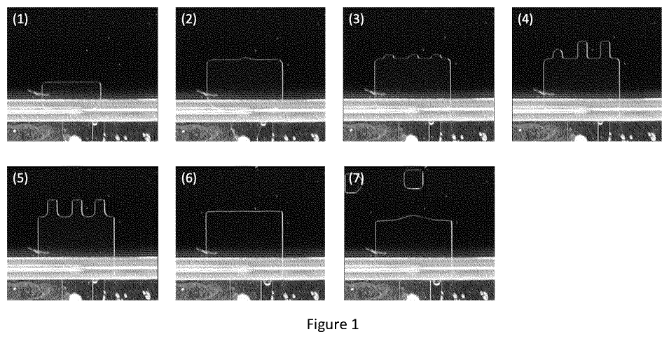

FIG. 2 shows a sequence of images (1-5) demonstrating precise formation of three aqueous reservoirs with calibration structures, driven with an air displacement pipette and a subsequent droplet dispense. The volume of the aqueous phase loaded is 7.5 μL, including both the reservoir to be formed and the calibration structures. The sizes of the actuated areas are 30×48 and 4×6 active elements on the device for main reservoir and calibration structures respectively. The time for filling the reservoir was approximately 120 seconds. The aqueous reagent loaded is 0.1% w/w Tween 20 in cell-free lysate, with dodecane as basefluid. Panel 5 of this figure shows droplet dispense of 245 nL.

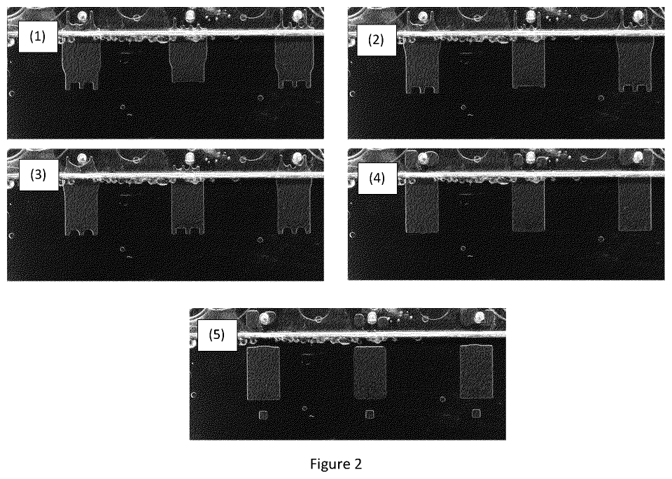

FIG. 3 shows a sequence of images showing pipette loading of reservoirs on the device using 3 calibration structures with variable dimensions as shown in the panel 4 of the Figure. The volume of the aqueous phase loaded is 6 μL, including both the reservoir to be formed and the calibration structures. The sizes of the actuated areas are 30×38 and (10×17, 6×18, 8×17) active elements on the device for main reservoir and calibration structures respectively. The time for filling the reservoir was 120 seconds. The aqueous reagent loaded is 0.05% w/w Tween 20 in 150 mM NaCl and 20 mM HEPES, with dodecane as basefluid.

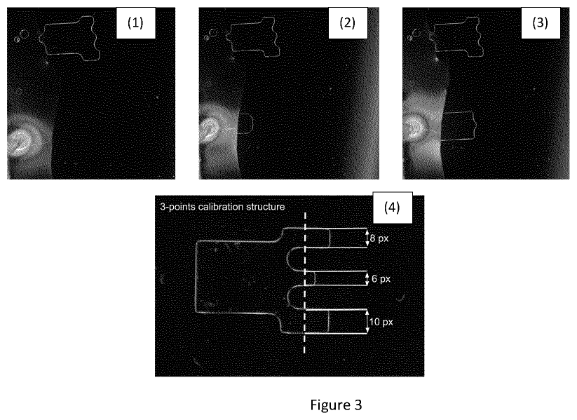

FIG. 4 shows the significance of precision in reservoir volume for droplet dispense coefficient of variance (CV). The overloaded reservoir (top line) only starts producing droplets with similar sizes to the ones of the reservoir with the calibration structures (bottom line) after 5 droplet dispenses. The first four droplets are over-sized. Both the overloaded reservoir and the reservoir with the calibration structures were loaded on the same DMF device and their droplets coefficient of variation (CV %) was equal to 19.3% (with 74% accuracy) and 8.7% (with 84% accuracy) respectively for overloaded and underloaded reservoir. Hence the calibration structures reduce variation and increase accuracy.

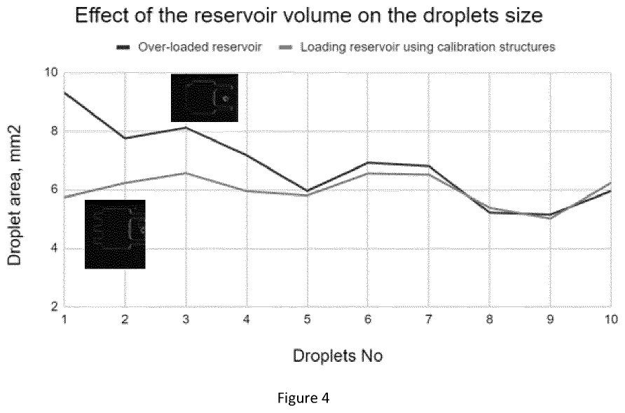

FIG. 5 shows a sequence of images (1-3) demonstrating formation of eight aqueous reservoirs with calibration structures, driven with an air displacement multichannel pipette. The arrows show the formation of calibration structures on the reservoirs. The volume of the aqueous phase loaded is μL, including both the reservoir to be formed and the calibration structures. The sizes of the actuated areas are 30×28 and 6×6 active elements on the device for main reservoir and calibration structures respectively. The time for filling the reservoir was 120 seconds. The aqueous reagent loaded is 0.05% w/w Pluronic F127 in Thermofisher elution buffer and food color red dye (1:1 dilution), with 0.1% span85 in DMPS (Dodecamethylpentasiloxane) as basefluid. (4) shows a snapshot of the electrical signal sent to the electrodes on the device during reservoir filling, where white represents electrodes with a potential applied. The calibration structures are shown by the arrow on the image. FIG. 5(1) shows a DMF device primed with basefuid FIG. 5 (2) shows initial stages of loading of reservoirs and FIG. 5 (3) shows two reservoirs filled to the correct volume while others are being pulled into the device with electrowetting forces. To run the experiment: Fill the device with the basefluid and initiate the sequence of electrical signal to actuate the electrodes. Aspirate the aqueous reagent to be filled into the DMF device in the pipette tip and then insert the pipette tip into the inlet port for the device. Slowly load the reagent into the device, until the formation of the calibration structures on the reservoir. Once the calibration structures are seen, pipette can be removed from the port to obtain the precisely loaded reservoir.

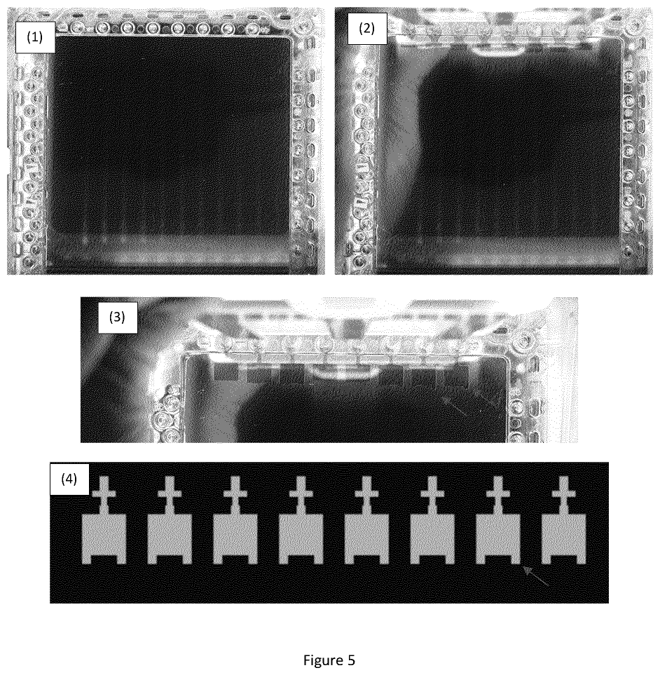

FIG. 6 (top) shows image of an EWoD based device with several aqueous reservoirs of different volume and showing calibration structures. The underfilled reservoirs are highlighted by a red arrow (without the calibration structure). (bottom) Image showing dispensed droplets from these reservoirs. Red square block shows missed droplet from underfilled reservoir. The reagent used is elution buffer with 0.1% span85 in DMPS base fluid.

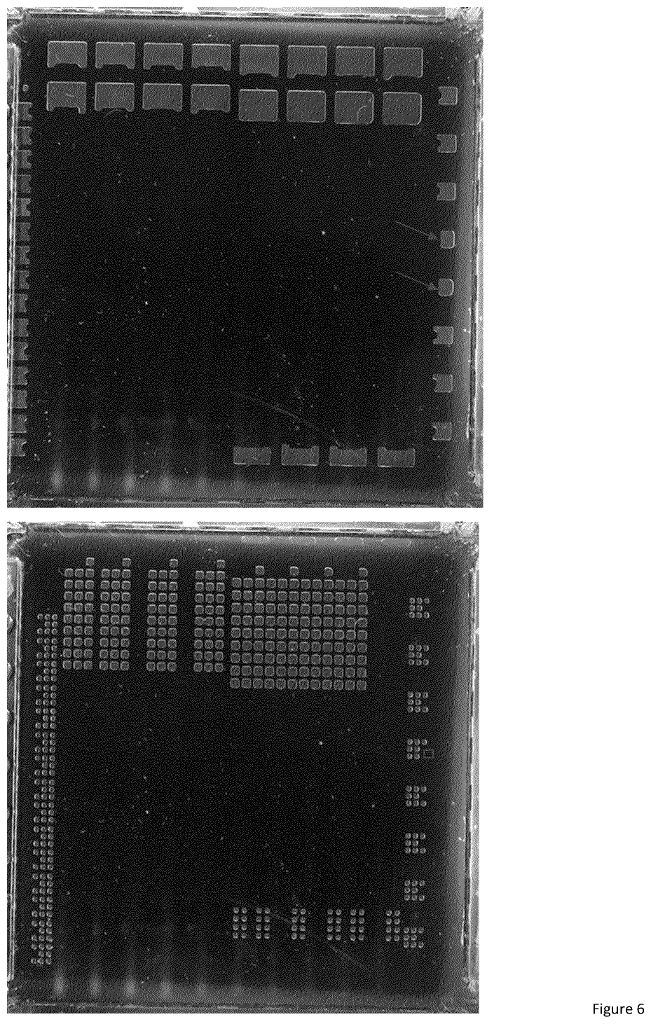

FIG. 7 shows the significance of under and overfilled reservoirs on droplet accuracy and precision using a recursive split method. The data shown is based on image processing of the fluorescence images and demonstrates that any underfilling of the aqueous reservoir results in a broad distribution of droplet sizes and a large CV. The reagent used for this analysis is 50 M fluorescein in buffer with 0.05% Pluronic F127 with 0.1% span85 in DMPS basefluid.

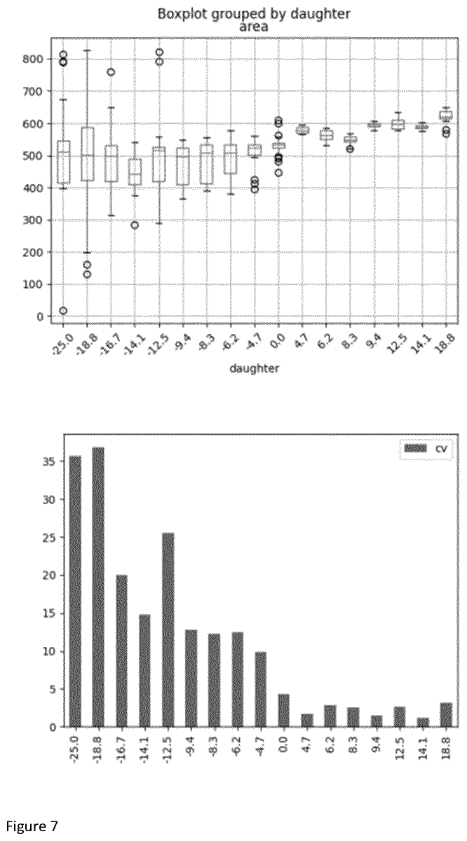

### DETAILED DESCRIPTION OF THE INVENTION

Disclosed herein is a method for dynamically controlling the shape of aqueous phase for the controlled filling of a reservoir on a planar electrowetting on dielectric (EWoD) device using protrusions from the reservoir. The term EWoD device refers to a digital microfluidic device (DMF) device having a plurality of electrodes and a fluidic gap. The DMF device is capable of enabling electrowetting.

Disclosed herein is a method for the controlled filling of a reservoir on a planar electrowetting on dielectric (EWoD) device, the method comprising:
a. taking an EWoD device having an internal or external reagent source liquid;
b. actuating reservoir electrodes to form a defined reservoir of aqueous liquid on the device; and
c. temporarily actuating electrodes on an opposing side of the reservoir to the source liquid to form one or more virtual calibration structures which are the last areas to fill, such that when the temporarily actuated electrodes are switched off the liquid becomes part of the reservoir, thereby accurately controlling the liquid area in the reservoir.

Disclosed herein is a method for the controlled filling of a reservoir on a planar electrowetting on dielectric (EWoD) device, the method comprising:
a. taking an EWoD device having an internal or external reagent source liquid;
b. actuating reservoir electrodes to form a defined reservoir of aqueous liquid on the device wherein the defined reservoir is separated from the source liquid by at least two electrodes; and
c. temporarily actuating electrodes on an opposing side of the reservoir to the source liquid to form one or more virtual calibration structures which are the last areas to fill, such that when the temporarily actuated electrodes are switched off the liquid becomes part of the reservoir, thereby accurately controlling the liquid area in the reservoir.

The source liquid may come from an external source via an inlet port or from a larger internal reservoir.

Disclosed herein is a method for the controlled filling of a reservoir on a planar electrowetting on dielectric (EWoD) device, the method comprising:
a. taking an EWoD device having an inlet port connected to an external reagent source;
b. actuating reservoir electrodes to form a defined reservoir of aqueous liquid on the device wherein the defined reservoir is separated from the inlet port by at least two electrodes so as not to overlap the inlet port; and
c. temporarily actuating electrodes on the opposing side of the reservoir to the inlet port to form one or more virtual calibration structures which are the last areas to fill, such that when the temporarily actuated electrodes are switched off the liquid becomes part of the reservoir, thereby accurately controlling the liquid area in the reservoir.

The formation of one or more virtual calibration structures allows for more accurate filling of the reservoir, therefore resulting in a more standardised size of droplets being dispensed from the reservoirs on the EWoD device. These calibration structures are elongated protrusions (“fork-like” structures) from the reservoir of the EWoD device which are the last areas to be filled by the external reagent source.

The virtual calibration structures are formed by actuating electrodes on the device and the internal liquid is held in place by electrode actuation to form elongated protrusions. The number of electrodes activated to form the width of the calibration structures is less than the width of the defined reservoir. The number of electrodes activated to form the width of the calibration structures can be less than half the number forming the width of the defined reservoir.

The entry of the liquid can be via the top or side of the digital microfluidic array. The top entry point may be via a hole in the planar surface. The side entry may be via a gap in the adhesive holding the two planar surfaces together or via a gap in the spacer material defining the cell gap. The inlet port can be formed by a hole in the upper surface or side of the planar EWoD device. The hole can be approximately 1 mm in diameter.

The array of electrodes can be formed on the opposing surface of the planar EWoD device to the surface having the entry hole.

The external source can take the form of a pipette or delivery tube. The pipette may be mechanical or electronic. The pipette may be single-channel or multi-channel. A multi-channel pipette may have 8-channels or 12-channels. Disclosed herein is a method of loading an EWoD device using a multichannel pipette, for example a pipette having 4, 8 or 12 channels.

The pitch between inlet ports may be 9 mm. The pitch between inlet ports may be 4.5 mm. The inlet ports have a pitch of 4.5 mm or a multiple of thereof. This would cover 24 well, 48 well, 96 well, 384 well ports. The pitch of the ports may be the same on each side of the device, or may be different sized. In this context the pitch refers to the distance between the centre of each inlet.

The inlets may be in the top plate of the DMF device. The ports may be holes in the side of the fluidic gap of the DMF device.

The inlets can be tapered in order to prevent the loading process from damaging the electrodes on the device via physical contact. For example where a multichannel pipette is placed in the inlet ports, the tapering prevents contacts between the ends of the pipette tips and the surface of the device.

Disclosed herein is the use of a multichannel pipette to load a DMF device. The multichannel pipette may be mechanical, electronic or attached to a liquid handling robot arm. The multichannel pipette may have 4, 8 or 12 channels. The multichannel pipette may be positive displacement pipette, an air displacement pipette, or a liquid displacement pipette.

Disclosed herein is the use of non-contact acoustic handling dispensing devices to load ports of a DMF device.

The multichannel pipette may contact the DMF device to form a seal between device and pipette. The multichannel pipette may dispense fluid in a non-contact manner, sometimes termed jet dispensing.

The volume of reagents loaded per inlet port may be between 1 microlitre and 50 microlitres. The volume may be between 1 microlitre and 20 microlitres. Different volumes may be loaded from different ports.

The electrode actuation to form the protrusions can occur for a period of greater than 1 second. The electrode actuation can occur for a period of 10-120 seconds.

Fluidic introduction to the reservoir can be improved using a virtual delivery path using temporary electrode actuation to form a temporary hydrophilic path across the otherwise hydrophobic surface. The path can form a temporal flow path between the inlet and the actuated reservoir using electrode actuation whilst the reagents are being delivered to the reservoir. The temporary delivery path can be formed by actuating greater than 2 electrodes. The delivery path can be formed by actuating between 10-500 electrodes arranged in an elongated pattern. The delivery path can formed by actuating electrodes arranged in an elongated pattern of 35 long by 8 wide. The delivery path can formed by actuating electrodes arranged in an elongated pattern of 22 electrodes long by 4 electrodes wide. The pattern can be 22-35 electrodes long and 4-8 wide.

The on-chip reservoir can be formed 2-500 electrodes away from the inlet port. The on-chip reservoir can be formed with 0.1 to 100 μL. Multiple on-chip reservoirs can be formed using a single inlet port. Alternatively multiple inlet ports can be used to combine reagents into one or more on-chip reservoirs.

The droplet release from the reservoir can be performed using any means of electrokinesis. The droplet can be moved using electrowetting-on-dielectric (EWoD). The electrical signal on the EWoD or optical EWoD device can be delivered through segmented electrodes, active-matrix thin-film transistors, or digital micromirrors.

The term digital microfluidic device refers to a device having a two-dimensional array of planar microelectrodes. The term excludes any devices simply having droplets in a flow of oil in a channel. The droplets are moved over the surface by electrokinetic forces by activation of particular electrodes. Upon activation of the electrodes the dielectric layer becomes less hydrophobic, thus causing the droplet to spread onto the surface. A digital microfluidic (DMF) device set-up is known in the art, and depends on the substrates used, the electrodes, the configuration of those electrodes, the use of a dielectric material, the thickness of that dielectric material, the hydrophobic layers, and the applied voltage.

An electrokinetic device includes a first substrate having a matrix of electrodes, wherein each of the matrix electrodes is coupled to a thin film transistor, and wherein the matrix electrodes are overcoated with a functional coating comprising: a dielectric layer in contact with the matrix electrodes, a conformal layer in contact with the dielectric layer, and a hydrophobic layer in contact with the conformal layer; a second substrate comprising a top electrode; a spacer disposed between the first substrate and the second substrate and defining an electrokinetic workspace; and a voltage source operatively coupled to the matrix electrodes.

The dielectric layer may comprise silicon dioxide, silicon oxynitride, silicon nitride, hafnium oxide, yttrium oxide, lanthanum oxide, titanium dioxide, aluminum oxide, tantalum oxide, hafnium silicate, zirconium oxide, zirconium silicate, barium titanate, lead zirconate titanate, strontium titanate, or barium strontium titanate. The dielectric layer may be between 10 nm and 100 μm thick. Combinations of more than one material may be used, and the dielectric layer may comprise more than one sublayer that may be of different materials.

The conformal layer may comprise a parylene, a siloxane, or an epoxy. It may be a thin protective parylene coating in between the insulating dielectric and the hydrophobic coating. Typically, parylene is used as a dielectric layer on simple devices. In this invention, the rationale for deposition of parylene is not to improve insulation/dielectric properties such as reduction in pinholes, but rather to act as a conformal layer between the dielectric and hydrophobic layers. The inventors find that parylene, as opposed to other similar insulating coatings of the same thickness such as PDMS (polydimethylsiloxane), prevent contact angle hysteresis caused by high conductivity solutions or solutions deviating from neutral pH for extended hours. The conformal layer may be between 10 nm and 100 μm thick.

The hydrophobic layer may comprise a fluoropolymer coating, fluorinated silane coating, manganese oxide polystyrene nanocomposite, zinc oxide polystyrene nanocomposite, precipitated calcium carbonate, carbon nanotube structure, silica nanocoating, or slippery liquid-infused porous coating.

The elements may comprise one or more of a plurality of array elements, each element containing an element circuit; discrete electrodes; a thin film semiconductor in which the electrical properties can be modulated by incident light; and a thin film photoconductor whose properties can be modulated by incident light.

The functional coating may include a dielectric layer comprising silicon nitride, a conformal layer comprising parylene, and a hydrophobic layer comprising an amorphous fluoropolymer. This has been found to be a particularly advantageous combination.

The electrokinetic device may include a controller to regulate a voltage provided to the individual matrix electrodes. The electrokinetic device may include a plurality of scan lines and a plurality of gate lines, wherein each of the thin film transistors is coupled to a scan line and a gate line, and the plurality of gate lines are operatively connected to the controller. This allows all the individual elements to be individually controlled.

### Devices

The manipulation of droplets by the application of electrical potential can be achieved on electrodes covered with an insulator or a dielectric or a series of insulators or dielectrics. Droplet manipulation as a result of an applied electrical potential is known as electrowetting. Electrokinesis occurs as result of a non-uniform electric field that influences the hydrostatic equilibrium of a dielectric liquid (dielectrophoresis or DEP) or a change in the contact angle of the liquid on solid surface (electrowetting-on-dielectric or EWoD). DEP can also be used to create forces on polarizable particles to induce their movement. The electrical signal can be transmitted to a discrete electrode, a transistor, an array of transistors, or a sheet of semi-conductor film whose electrical properties can be modulated by an optical signal.

EWoD phenomena occur when droplets are actuated between two parallel electrodes covered with a hydrophobic insulator or dielectric. The electric field at the electrode-electrolyte interface induces a change in the surface tension, which results in droplet motion as a result of a change in droplet contact angle. The electrowetting effect can be quantitatively treated using Young-Lippmann equation:

$$cos θ - cos {θ}_{0} = ( 1 / 2 γ LG ) c \cdot {V}^{2}$$

where θ₀ is the contact angle when the electric field across the interfacial layer is zero, γ_{LG} is the liquid-gas tension, c is the specific capacitance (given as εᵣ. ε₀/t, where εᵣ is dielectric constant of the insulator/dielectric, ε₀ is permittivity of vacuum, t is thickness) and V is the applied voltage or electrical potential. The change in contact angle (inducing droplet movement) is thus a function of surface tension, electrical potential, dielectric thickness, and dielectric constant.

When a droplet is actuated by EWoD, there are two opposing sets of forces that act upon it: an electrowetting force induced by electric field and resistant forces that include the drag forces resulting from the interaction of the droplet with filler medium and the contact line friction (ref). The minimum voltage applied to balance the electrowetting force with the sum of all drag forces (threshold voltage) is variably determined by the thickness-to-dielectric contact ratio of the insulator/dielectric, (t/εᵣ)^{1/2}. Thus, to reduce actuation voltage, it is required to reduce (t/εᵣ)^{1/2} (i.e., increase dielectric constant or decrease insulator/dielectric thickness). To achieve low voltage actuation, thin insulator/dielectric layers must be used. However, the deposition of high quality thin insulator/dielectric layers is a technical challenge, and these thin layers are easily damaged before the desired electrowetting contact angle is large enough to drive the droplet is achieved. Most academic studies thus report the use of much higher voltages >100V on easily fabricated, thick dielectric films (>3 μm) to effect electrowetting.

High voltage EWoD-based devices with thick dielectric films, however, have limited industrial applicability largely due to their limited droplet multiplexing capability. The use of low voltage devices including thin-film transistors (TFT) and optically-activated amorphous silicon layers (a-Si) have paved the way for the industrial adoption of EWoD-based devices due to their greater flexibility in addressing electrical signals in a highly multiplex fashion. The driving voltage for TFTs or optically-activated a-Si are low (typically <15 V). The bottleneck for fabrication and thus adoption of low voltage devices has been the technical challenge of depositing high quality, thin film insulators/dielectrics. Hence there has been a particular need for improving the fabrication and composition of thin film insulator/dielectric devices.

Typically, the electrodes (or the array elements) used for EWoD are covered with (i) a hydrophilic insulator/dielectric and a hydrophobic coating or (ii) a hydrophobic insulator/dielectric. Commonly used hydrophobic coatings comprise of fluoropolymers such as Teflon AF 1600 or CYTOP. The thickness of this material as a hydrophobic coating on the dielectric is typically <100 nm and can have defects in the form of pinholes or a porous structure; hence, it is particularly important that the insulator/dielectric is pinhole free to avoid electrical shorting. Teflon has also been used as an insulator/dielectric, but it has higher voltage requirements due to its low dielectric constant and the thickness required to make it pinhole free. Other hydrophobic insulator/dielectric materials can include polymer-based dielectrics such as those based on siloxane, epoxy (e.g. SU-8), or parylene (e.g., parylene N, parylene C, parylene D, or parylene HT). Due to minimal contact angle hysteresis and a higher contact angle with aqueous solutions, Teflon is still used as a hydrophobic topcoat on these insulator/dielectric polymers. However, there are difficulties in reliably producing <1 micron pinhole-free coatings of parylene or SU-8; thus, the thickness of these materials is typically kept at a 2-5 microns at the cost of increased voltage requirements for electrowetting. It has also been reported that traditional EWoD devices with parylene C are easily broken and unstable for repeated droplet manipulation with cell culture medium.

Multi-layer insulator devices deposited with metal-oxide and parylene C films have been used to produce a more robust insulator/dielectric and enable operations with lower applied voltages. Inorganic materials, such metal oxides and semiconductor oxides, commonly used in the CMOS industry as “gate dielectrics”, have been used as insulator/dielectric for EWoD devices. They offer the advantage of utilizing standard cleanroom processes for thin film depositions (<100 nm). These materials are inherently hydrophilic, requiring an additional hydrophobic coating, and can be prone to pinhole formation as a result of thin film layer deposition process. Together with the need for lower voltage operations of EWoD, recent developmental work has focused on (1) using materials with improved dielectric properties (e.g., using high-dielectric constant insulators/dielectrics), (2) optimizing the fabrication process to make the insulator/dielectric pinhole free to avoid dielectric breakdown.

The devices can be used for any biochemical assay process involving high solute (ionic) strength solutions where the high concentration of ions would otherwise degrade and prevent use of prior art devices. The devices are particularly advantageous for processes involving the synthesis of biomolecules such as for example nucleic acid synthesis, for example using template independent strand extensions, or cell-free protein expression using a population of different nucleic acid templates.

### Applications of the Invention

The invention can be used in a myriad of different applications. In particular the invention can be used to move cells, nucleic acids, nucleic acid templates, proteins, initiation oligonucleotide sequences for nucleic acid synthesis, beads, magnetic beads, cells immobilised on magnetic beads, or biopolymers immobilised on magnetic beads.

In these applications the steps of disposing an aqueous droplet having an ionic strength on a first matrix electrode and providing a differential electrical potential may be repeated many times. They may be repeated over 1000 times or over 10,000 times, sometimes over a 24 hour period.

### Enzymatic DNA Synthesis Applications

The present method can be used in the synthesis of nucleic acids, such as phosphoramidite-based nucleic acid synthesis, templated or non-templated enzymatic nucleic acid synthesis, or more specifically, terminal deoxynucleotidyl transferase (TdT) mediated addition of 3′-O-reversibly terminated nucleoside 5′-triphosphates to the 3′-end of 5′-immobilized nucleic acids. During enzymatic nucleic acid synthesis, the following steps are taken on the instrument:
I. Addition solution containing TdT, optionally pyrophosphatase (PPiase), 3′-O-reversibly terminated dNTPs, and required buffer (including salts and necessary reaction components such as metal divalents) is brought to a reaction zone containing an immobilized nucleic acid, where the nucleic acid is immobilized on a surface such as through magnetic beads via a covalent linkage to the 5′ terminus of the nucleic acid. The initial immobilized nucleic acid may be known as an initiator oligonucleotides and comprises N nucleotides, for example 3-100 nucleotides, preferably 10-80 nucleotides, and more preferably 20-65 nucleotides. Initiator oligonucleotides may contain a cleavage site, such as a restriction site or a non-canonical DNA base such as U or 8-oxoG. Addition solution may optionally contain a phosphate sensor, such as E. coli phosphate-binding protein conjugated to MDCC fluorophore, to assess the quality of nucleic acid synthesis as a fluorescent output. dNTPs can be combined in ratios to make DNA libraries, such as NNK syntheses.
II. Wash solution, either in bulk or in discrete droplets, is applied to reaction zones to wash away the addition solution. Wash solution typically has a high solute concentration (>1 M NaCl).
III. Deprotection solution, either in bulk or in discrete droplets, is applied to reaction zones to deprotect the 3′-O-reversible terminator added to the immobilized nucleic acids in the immobilized nucleic acid zone in step I. Deprotection solution typically has a high solute concentration.
IV. Wash solution, either in bulk or in discrete droplets, is applied to reaction zones to wash away the deprotection solution.
V. Steps I-IV are repeated until desired sequences are synthesized, for example steps I-IV are repeated 10, 50, 100, 200 or 1000 times.

The present method can be used in the preparation of oligonucleotide sequences, either via synthesis or assembly. The device allows synthesis and movement of defined sequences. Using the present method the initiation sequences can be modified at a specific location above an electrode and the extended oligonucleotides prepared. The initiation sequences at different locations can be exposed to different nucleotides, thereby synthesising different sequences in different regions of the electrokinetic device.

After synthesis of a defined population of different sequences in different regions of the electrokinetic device, the sequences can be further assembled in longer contiguous sequences by joining two or more synthesised strands together.

Described herein is a method for preparing a contiguous oligonucleotide sequence of at least 2n bases in length comprising taking the electrokinetic device as described herein having a plurality of immobilised initiation oligonucleotide sequences, one or more of which contains a cleavage site, using the initiation oligonucleotide sequences to synthesise a plurality of immobilised oligonucleotide sequences of at least n bases in length, using cycles of extension of reversibly blocked nucleotide monomers, selectively cleaving at least two of the immobilised oligonucleotide sequences of least n bases in length into a reaction solution whilst leaving one or more of the immobilised oligonucleotide sequences attached, hybridizing at least two of the cleaved oligonucleotides to each other, to form a splint, and hybridizing one end of the splint to one of the immobilized oligonucleotide sequences and joining at least one of the cleaved oligonucleotides to the immobilised oligonucleotide sequences, thereby preparing a contiguous oligonucleotide sequence of at least 2n bases in length.

The present invention can be used to automate the movements of droplets in a cartridge. For example, droplets intended for analysis can be moved according to the present invention. The present invention could be incorporated into a cartridge used for local clinician diagnostics. For example it could be used in conjunction with nucleic acid amplification testing (NAAT) to determine nucleic acid targets in, for example, genetic testing for indications such as cancer biomarkers, pathogen testing for example detecting bacteria in a blood sample or virus detection, such as a coronavirus, e.g. SARS-CoV-2 for the diagnosis of COVID-19.

The device may be thermocycled to enable nucleic acid amplification, or the device may be held at a desired temperature for isothermal amplification. Having different sequences synthesised in different regions of the device allows multiplex amplification using different primers in different regions of the device.

Furthermore the invention can be used in conjunction with next generation sequencing in which DNA is synthesised by the addition of nucleotides and large numbers of samples are sequenced in parallel. The present invention can be used to accurately locate the individual samples used in next generation sequencing.

The invention can be used to automate library preparation for next generation sequencing. For example the steps of ligation of sequencing adaptors can be carried out on the device. Amplification of a selective subset of sequences from a sample can then have adaptors attached to enable sequencing of the amplified population.

### Protein Expression Applications

The method of moving aqueous droplets may also be used to help facilitate cell-free expression of peptides or proteins. In particular, droplets containing a nucleic acid template and a cell-free system having components for protein expression in an oil-filled environment can be moved using a method of the invention in the described electrokinetic device.

Disclosed herein is a method for the real-time monitoring of in-vitro protein synthesis comprising
a. In-vitro transcription and translation of a protein of interest fused to a peptide tag; and
b. monitoring the presence of the peptide tag using a further polypeptide which in the presence of the peptide tag produces a detectable signal.

Disclosed herein is a method for the monitoring of cell-free protein synthesis in a droplet on a digital microfluidic device comprising
a. cell-free transcription and translation of a protein of interest fused to a peptide tag; and
b. monitoring the presence of the peptide tag using a further polypeptide which in the presence of the peptide tag produces a detectable signal.

The use of the terms “in-vitro” and “cell-free” may be used interchangeably herein.

The detectable signal may be for example fluorescence or luminescence. The detectable signal may also be caused by the binding of a ligand to the complemented oligopeptide, peptide, or polypeptide tag fused to the protein of interest.

The detectable signal may also be caused by the binding of the polypeptide to the protein of interest fused to a His-tag.

Any in-vitro transcription and translation may be used, for example extract-based systems derived from rabbit reticulocyte lysate, human lysate, Chinese Hamster Ovary lysate, a wheat germ, HEK293 lysate, E. coli lysate, yeast lysate.

Alternatively the in-vitro transcription and translation may be assembled from purified components, for example a system of purified recombinant elements (PURE).

The in-vitro transcription and translation may be coupled or uncoupled.

The peptide tag may be one component of a fluorescent protein and the further polypeptide a complementary portion of the fluorescent protein. The fluorescent protein could include sfGFP, GFP, ccGFP, eGFP, deGFP, frGFP, eYFP, eBFP, eCFP, Citrine, Venus, Cerulean, Dronpa, DsRED, mKate, mCherry, mRFP, FAST, SmURFP, miRFP670nano. For example the peptide tag may be GFP₁₁ and the further polypeptide GFP₁₋₁₀. The peptide tag may be one component of sfCherry. The peptide tag may be sfCherry₁₁ and the further polypeptide sfCherry₁₋₁₀. The peptide tag may be CFAST₁₁ or CFAST₁₀ and the further polypeptide NFAST in the presence of a hydroxybenzylidene rhodanine analog.

The peptide tag may also be one component of a protein that forms a detectable substrate, such as a luminescent or colorigenic substrate. The protein could include beta-galactosidase, beta-lactamase, or luciferase.

The protein may be fused to multiple tags. For example the protein may be fused to multiple GFP₁₁ peptide tags and the synthesis occurs in the presence of multiple GFP₁₋₁₀ polypeptides. For example the protein may be fused to multiple sfCherry₁₁ peptide tags and the synthesis occurs in the presence of multiple sfCherry₁₋₁₀ polypeptides. The protein of interest may be fused to one or more sfCherry₁₁ peptide tags and one or more GFP₁₁ peptide tags and the synthesis occurs in the presence of one or more GFP₁₋₁₀ polypeptides and one or more sfCherry₁₋₁₀ polypeptides.

Any protein of interest may be synthesised. The protein may be an enzyme, for example a terminal deoxynucleotidyl transferase (TdT) enzyme or a truncated version thereof or the homologous amino acid sequence of a terminal deoxynucleotidyl transferase (TdT) enzyme in other species or the homologous amino acid sequence of Polμ, Polβ, Polλ, and Polθ of any species or the homologous amino acid sequence of X family polymerases of any species.

Protein expression typically requires an ample supply of oxygen. The most convenient and high yielding way to power CFPS is via oxidative phosphorylation where O₂ serves as the final electron acceptor; however, there are other ways that involve replenishing with energy molecules not involved in oxidative phosphorylation. In a confined microfluidic or digital microfluidic system of droplets, insufficient oxygen is available to enable efficient protein synthesis.

Described herein are improved methods allowing for the cell-free expression of peptides or proteins in a digital microfluidic device. Included is a method for the cell-free expression of peptides or proteins in a microfluidic device wherein the method comprises one or more droplets containing a nucleic acid template (i.e., DNA or RNA) and a cell-free system having components for protein expression in an oil-filled environment, and moving said droplets using electrokinesis. The components for the cell-free protein synthesis droplet can be pre-mixed prior to introduction to or mixed on the digital microfluidic device.

The droplet can be repeatedly moved for at least a period of 30 minutes whilst the protein is expressed. The droplet can be repeatedly moved for at least a period of two hours whilst the protein is expressed. The droplet can be repeatedly moved for at least a period of twelve hours whilst the protein is expressed. The act of moving the droplet allows oxygen to be supplied to the droplet and dispersed throughout the droplet. The act of moving improves the level of protein expression over a droplet which remains static.

The droplet can be moved using any means of electrokinesis. The droplet can be moved using electrowetting-on-dielectric (EWoD). The electrical signal on the EWoD or optical EWoD device can be delivered through segmented electrodes, active-matrix thin-film transistors, or digital micromirrors.

The oil in the device can be any water immiscible liquid. The oil can be mineral oil, silicone oil, an alkyl-based solvent such as decane or dodecane, or a fluorinated oil. The oil can be oxygenated prior to or during the expression process. Alternatively, the device can be an air-filled device where droplets containing cell-free protein synthesis reagents are rapidly moved into position and fixed into an array under a humidified gas to prevent evaporation. Humidification can be achieved by enclosing or sealing the digital microfluidic device and providing on-board reagent reservoirs. Additionally, humidification can be achieved by connecting an aqueous reservoir to an enclosed or sealed digital microfluidic device. The aqueous reservoir can have a defined temperature or solute concentration in order to provide specific relative humidities (e.g., a saturated potassium sulfate solution at 30° C.).

A source of supplemental oxygen can be supplied to the droplets. For example droplets or gas bubbles containing gaseous or dissolved oxygen can be merged with the droplets during the protein expression. Additionally, a source of supplemental oxygen can be found by oxygenating the oil that is used as the filler medium. It is well-known in the art that oils such as hexadecane, HFE-7500, and others can be oxygenated to support the oxygen requirements of cell growth, especially E. coli cell growth (RSC Adv., 2017, 7, 40990-40995). Oxygenation can be achieved by aerating the oil with pure oxygen or atmospheric air.

The droplets can be formed before entering the microfluidic device and flowed into the device. Alternatively the droplets can be merged on the device. Included is a method comprising merging a first droplet containing a nucleic acid template such as a plasmid with a second droplet containing a cell-free extract having the components for protein expression to form a combined droplet capable of cell-free protein synthesis.

The droplets can be split on the device either before or after expression. Included herein is a method further comprising splitting the aqueous droplet into multiple droplets. If desired the split droplets can be screened with further additives. Included is a method wherein one or more of the split droplets are merged with additive droplets for screening.

The cell-free expression of peptides or proteins can use a cell lysate having the reagents to enable protein expression. Common components of a cell-free reaction include an energy source, a supply of amino acids, cofactors such as magnesium, and the relevant enzymes. A cell extract is obtained by lysing the cell of interest and removing the cell walls, DNA genome, and other debris by centrifugation. The remains are the cell machinery including ribosomes, aminoacyl-tRNA synthetases, translation initiation and elongation factors, nucleases, etc. Once a suitable nucleic acid template is added, the nucleic acid template can be expressed as a peptide or protein using the cell derived expression machinery.

Any particular nucleic acid template can be expressed using the system described herein. Three types of nucleic acid templates used in CFPS include plasmids, linear expression templates (LETs), and mRNA. Plasmids are circular templates, which can be produced either in cells or synthetically. LETs can be made via PCR. While LETs are easier and faster to make, plasmid yields are usually higher in CFPS. mRNA can be produced through in-vitro transcription systems. The methods use a single nucleic acid template per droplet. The methods can use multiple droplets having a different nucleic acid template per droplet.

An energy source is an important part of a cell-free reaction. Usually, a separate mixture containing the needed energy source, along with a supply of amino acids, is added to the extract for the reaction. Common sources are phosphoenolpyruvate, acetyl phosphate, and creatine phosphate. The energy source can be replenished during the expression process by adding further reagents to the droplet during the process.

The cell-free extract having the components for protein expression includes everything required for protein expression apart from the nucleic acid template. Thus the term includes all the relevant ribosomes, enzymes, initiation factors, nucleotide monomers, amino acid monomers, metal ions and energy sources. Once the nucleic acid template is added, protein expression is initiated without further reagents being required.

Thus the cell-lysate can be supplemented with additional reagents prior to the template being added. The cell-free extract having the components for protein expression would typically be produced as a bulk reagent or ‘master mix’ which can be formulated into many identical droplets prior to the distinct template being separately added to separate droplets. Common cell extracts in use today are made from E. coli (ECE), rabbit reticulocytes (RRL), wheat germ (WGE), insect cells (ICE) and Yeast Kluyveromyces (the D2P system). All of these extracts are commercially available.

Rather than originating from a cell extract, the cell-free system can be assembled from the required reagents. Systems based on reconstituted, purified molecular reagents are commercially available, for example the PURE system for protein production, and can be used as supplied. The PURE system is composed of all the enzymes that are involved in transcription and translation, as well as highly purified 70S ribosomes. The protein synthesis reaction of the PURE system lacks proteases and ribonucleases, which are often present as undesired molecules in cell extracts.

Once the CFPS reagents have been enclosed in the droplets, additional reagents can be supplied by merging the original droplet with a second droplet. The second droplet can carry any desired additional reagents, including for example oxygen or ‘power’ sources, or test reagents to which it is desired to expose to the expressed protein.

The droplets can be aqueous droplets. The droplets can contain an oil immiscible organic solvent such as for example DMSO. The droplets can be a mixture of water and solvent, providing the droplets do not dissolve into the bulk oil.

The droplets can be in a bulk oil layer. A dry gaseous environment simply dries the bubbles onto the surface during the expression process, leaving comet type smears of dried material by evaporation. Thus the device is filled with liquid for the expression process. Alternatively, the aqueous droplets can be in a humidified gaseous environment. A device filled with air can be sealed and humidified in order to provide an environment that reduces evaporation of CFPS droplets.

The droplets containing the cell-free extract having the components for protein expression will therefore typically be in the oil filled environment before the nucleic acid templates are added to the droplets. The templates can be added by merging droplets on the microfluidic device. Alternatively, the templates can be added to the droplets outside the device and then flowed into the device for the expression process. For example the expression process can be initiated on the device by increasing the temperature. The expression system typically operates optimally at temperatures above standard room temperatures, for example at or above 29° C.

The expression process typically takes many hours. Thus the process should be left for at least 30 minutes or 1 hour, typically at least 2 hours. Expression can be left for at least 12 hours. During the process of expression the droplets should be moved within the device. The moving improves the process by mixing the reagents and ensuring sufficient oxygen is available within the droplet. The moving can be continuous, or can be repeated with intervening periods of non-movement.

Thus the aqueous droplet can be repeatedly moved for at least a period of 30 minutes or one hour whilst the protein is expressed. The aqueous droplet can be repeatedly moved for at least a period of two hours whilst the protein is expressed. The aqueous droplet can be repeatedly moved for at least a period of twelve hours whilst the protein is expressed. The act of moving the droplet allows mixing within the droplet, and allows oxygen or other reagents to be supplied to the droplet. The act of moving improves the level of protein expression over a droplet which remains static.

The filler liquid may be a hydrophobic or non-ionic liquid. For example the filler liquid may be decane or dodecane. The filler fluid may be a silicone oil such as dodecamethylpentasiloxane (DMPS). The filler liquid may contain a surfactant, for example a sorbitan ester such as Span 85.

A source of supplemental oxygen can be supplied to the droplets. For example droplets or gas bubbles containing gaseous or dissolved oxygen can be merged with the aqueous droplets during the protein expression. Alternatively the source of oxygen can be a molecular source which releases oxygen. Alternatively the droplets can be moved to an air/liquid boundary to enable increased diffusion of oxygen from a gaseous environment. Alternatively the oil can be oxygenated. Alternatively the droplets can be presented in a humidified air filled device.

The droplet can be formed before entering the microfluidic device and flowed into the device. Alternatively the droplets can be merged on the device. Included is a method comprising merging a first droplet containing a nucleic acid template such as a plasmid with a second droplet containing a cell-free system having the components for protein expression to form the droplet.

The droplets can be split on the device either before, during or after expression. Included herein is a method further comprising splitting the droplet into multiple droplets. If desired the split droplets can be screened with further additives. Included is a method wherein one of more of the split droplets are merged with additive droplets for screening.

Through an affinity tag, such as a FLAG-tag, HIS-tag, GST-tag, MBP-tag, STREP-tag, or other form of affinity tag, CFPS-expressed proteins can be immobilized to a solid-support affinity resin and fresh batches of CFPS reagent can be delivered over the said resin. Thus, renewed reagents can be used to carry out protein synthesis, closely mimicking industrial methods of continuous flow (CF) and continuous exchange (CE) CFPS. By mimicking CF- and CE-CFPS, users can scale up their CFPS production methods.

Droplets can also contain additives to reduce the effects of biofouling on digital microfluidic surfaces. Specifically, droplets containing CFPS components can also contain additives such as surfactants or detergents to reduce the effects of biofouling on the hydrophobic or superhydrophobic surface of a digital microfluidic device (Langmuir 2011, 27, 13, 8586-8594). Such droplets may use antifouling additives such as TWEEN 20, Triton X-100, and/or Pluronic F127. Specifically, droplets containing CFPS components may contain TWEEN 20 at 0.1% v/v, Triton X-100 at 0.1% v/v, and/or Pluronic F127 at 0.08% w/v.

Rather than adding surfactants to the aqueous sample, it is instead possible to add surfactant, such as a sorbitan ester such as Span85 (e.g. Sorbitan trioleate, Sigma Aldrich, SKU 8401240025), to the oil. This has the advantages of enabling CFPS reactions to proceed on-DMF without dilution or adulteration. Additionally, it simplifies the sample preparation procedure for setting up the reactions, increasing the ease of use and the consistency of results. Using 1% w/w Span85 in dodecane allows for dilution-free CFPS reactions on-DMF, as well as dilution-free detection of the expressed non-fluorescent proteins. Other surfactants besides Span85, and oils other than dodecane could be used. A range of concentrations of Span85 could be used. Surfactants could be nonionic, anionic, cationic, amphoteric or a mixture thereof. Oils could be mineral oils or synthetic oils, including silicone oils, petroleum oils, and perfluorinated oils. Surfactants can have a detrimental effect on (1) the CFPS reactions and (2) the efficiency of the detection system (if the detection system involves complementation of a tag and detector). For example, by performing the CFPS reaction on-DMF with oil-surfactant mix, the detection of the expressed protein can also proceed without dilution and without adding aqueous surfactant. It has been shown that surfactants reduce the efficiency of some detection systems, including but not limited to the Split GFP (e.g. GFP11/GFP1-10) system, so removing surfactants from the reagent mix and instead adding them to the oil can be beneficial.

The peptide tag can be attached to the C or N terminus of the protein. The peptide tag may be one component of a green fluorescent protein (GFP). For example the peptide tag may be GFP₁₁ and the further polypeptide GFP₁₋₁₀. The peptide tag may be one component of sfCherry. The peptide tag may be sfCherry₁₁ and the further polypeptide sfCherry₁₋₁₀.

The protein may be fused to multiple tags. For example the protein may be fused to multiple GFP₁₁ peptide tags and the synthesis occurs in the presence of multiple GFP₁₋₁₀ polypeptides. For example the protein may be fused to multiple sfCherry₁₁ peptide tags and the synthesis occurs in the presence of multiple sfCherry₁₋₁₀ polypeptides. The protein of interest may be fused to one or more sfCherry₁₁ peptide tags and one or more GFP₁₁ peptide tags and the synthesis occurs in the presence of one or more GFP₁₋₁₀ polypeptides and one or more sfCherry₁₋₁₀ polypeptides.

Where used herein “and/or” is to be taken as specific disclosure of each of the two specified features or components with or without the other. For example “A and/or B” is to be taken as specific disclosure of each of (i) A, (ii) B and (iii) A and B, just as if each is set out individually herein. Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

1. A method for the controlled filling of a reservoir on a digital microfluidic device (DMF) device having a plurality of electrodes, the method comprising:
a. taking an EWoD device having an internal or external reagent source of liquid;
b. actuating reservoir electrodes to form a defined reservoir of aqueous liquid on the device; and
c. temporarily actuating electrodes on an opposing side of the reservoir to the source liquid to form one or more virtual calibration structures which are the last areas to fill, such that when the temporarily actuated electrodes are switched off the liquid becomes part of the reservoir, thereby accurately controlling the liquid area in the reservoir.

2. A method according to claim 1 for the controlled filling of a reservoir on a digital microfluidic device (DMF) device having a plurality of electrodes, the method comprising:
a. taking an EWoD device having an internal or external reagent source liquid;
b. actuating reservoir electrodes to form a defined reservoir of aqueous liquid on the device wherein the defined reservoir is separated from the source liquid by at least two electrodes; and
c. temporarily actuating electrodes on an opposing side of the reservoir to the source liquid to form one or more virtual calibration structures which are the last areas to fill, such that when the temporarily actuated electrodes are switched off the liquid becomes part of the reservoir, thereby accurately controlling the liquid area in the reservoir.

3. The method according to claim 1 or claim 2 wherein the liquid source is an inlet port.

4. The method according to claim 1 or claim 2 wherein the liquid source is a larger internal reservoir.

5. The method according to any one of claims 1 to 4, wherein the calibration structures are elongated protrusions.

6. The method according to claim 5, wherein there are 2 or more elongated protrusions per reservoir.

7. The method according to claim 6, wherein there are 3 elongated protrusions per reservoir.

8. The method according to any one preceding claim, wherein the reservoir comprises X by Y pixels where X is 10-30 and Y is 10-50.

9. The method according to any one preceding claim, wherein the reservoir comprises X by Y pixels where X is 16 and Y is 16.

10. The method according to any one preceding claim, wherein the reservoir has a capacity of 1 to 10 microlitres.

11. The method according to any one preceding claim, wherein the opposing side is at 180 degrees to the incoming flow.

12. The method according to any one preceding claim, wherein the opposing side is at 90 degrees to the incoming flow.

13. The method according to any one preceding claim, wherein the area of each of the calibration structures is 1 to 10% of the reservoir area.

14. The method according to any one preceding claim, wherein the digital microfluidic device is a AM-EWoD device.

15. The method according to any one preceding claim, wherein the inlet port is formed by a hole in the top surface of a digital microfluidic device.

16. The method according to any one preceding claim, wherein the inlet port is formed by a hole in the spacer defining the fluidic gap of the DMF device.

17. The method according to any one preceding claim, wherein the array of electrodes is formed on the surface of the digital microfluidic device opposing the inlet port.

18. The method according to any one preceding claim, wherein the inlet port is connected to a pipette or delivery tube.

19. The method according to any one preceding claim, wherein the external source takes the form of a multichannel pipette connected to multiple inlet ports in order to form multiple reservoirs simultaneously.

20. The method according to any one preceding claim, wherein the aqueous reagent being loaded into the device enables biopolymer synthesis.

21. The method according to claim 20, wherein the aqueous reagent contains a DNA construct or a cell-free lysate.

22. The method according to claim 20, wherein the aqueous reagent contains a terminal deoxynucleotidyl transferase or a nucleotide triphosphate.
